(19) United States
(12) Patent Application Publication
(10) Pub. No.: US 2025/0126490 A1
(43) Pub. Date: Apr. 17, 2025

(54) COMPUTING-AWARE TRAFFIC STEERING METHOD, APPARATUS, AND SYSTEM IN MOBILE NETWORK

(71) Applicant: FOUNDATION OF SOONGSIL UNIVERSITY-INDUSTRY COOPERATION, Seoul (KR)

(72) Inventor: Young Han KIM, Seoul (KR)

(73) Assignee: FOUNDATION OF SOONGSIL UNIVERSITY-INDUSTRY COOPERATION, Seoul (KR)

(21) Appl. No.: 18/816,390

(22) Filed: Aug. 27, 2024

(30) Foreign Application Priority Data
Oct. 17, 2023 (KR) 10-2023-0138884

(51) Int. Cl. H04W 24/02; H04L 45/00; H04W 76/10

(52) U.S. Cl. CPC H04W 24/02; H04L 45/566; H04W 76/10

(57) ABSTRACT

The present disclosure discloses a computing-aware traffic steering method, apparatus and system in a mobile network. According to the present disclosure, there is provided a computing-aware traffic steering method of mobile network control plane, the method including in a case where it is confirmed that there is no target data network access identifier (DNAI) mapped to a service ID when a PDU session establishment request including the service ID of a user equipment (UE) is made, transmitting the service ID and user plane path information to a CATS controller in a computing-aware traffic steering (CATS) network environment using segment routing, and reconfiguring a user plane path for accessing an optimal service contact instance IP address determined as one of a plurality of service contact instances based on a base station connected by the UE and computing and networking metrics in conjunction with the CATS controller.

### CROSS-REFERENCE TO RELATED APPLICATION

This application claims under 35 U.S.C. § 119(a) the benefit of Korean Patent Application No. 10-2023-0138884 filed on Oct. 17, 2023, the entire contents of which are incorporated herein by reference.

### BACKGROUND

### (a) Technical Field

The present disclosure relates to a computing-aware traffic steering method, apparatus, and system in a mobile network.

### (b) Background Art

Recently, for better availability, service instances running the same service are deployed simultaneously in multiple geographically distributed edge sites.

In such an environment, in order to satisfy user experience and optimize computing resources, it is necessary to transfer user traffic to the optimal edge site based on both computing and networking information.

An Internet engineering task force (IETF) proposed computing-aware traffic steering (CATS) framework for the above-described processing in general Internet infrastructure.

The CATS framework provides an approach to making computing and networking-aware traffic steering decisions in an environment where services are deployed in multiple locations.

The CATS framework is an overlay framework that dynamically selects a service contact instance suitable for a user's service request by combining computing and networking metrics.

Here, the service contact instance is a service function that is responsible for receiving requests to the instance to connect the requested service to the actual service instance.

However, the networking environment of the CATS framework targets the general Internet, and a method supporting computing-aware traffic steering has not yet been proposed for the mobile network architecture.

SUMMARY OF THE DISCLOSURE

In order to solve the problems of the above-mentioned prior art, the present disclosure proposes a computing-aware traffic steering method, apparatus, and system capable of dynamically steering user traffic to the optimal service instance in a mobile network.

In order to achieve the above-described objects, according to one embodiment of the present disclosure, there is provided a computing-aware traffic steering method of mobile network control plane, the method including: in a case where it is confirmed that there is no target data network access identifier (DNAI) mapped to a service ID when a PDU (Packet Data Unit) session establishment request including the service ID of a user equipment (UE) is made, transmitting the service ID and user plane path information to a CATS controller in a computing-aware traffic steering (CATS) network environment using segment routing; and reconfiguring a user plane path for accessing an optimal service contact instance IP address determined as one of a plurality of service contact instances based on a base station location connected by the UE and computing and networking metrics in conjunction with the CATS controller.

The mobile network control plane may be a control plane of a 5G or 6G mobile communication network, and the transmitting may include calling a PDU session create session management (SM) context request to a corresponding session management function (SMF) according to a data network name (DNN) corresponding to the service ID when an access and mobility management function (AMF) of the control plane receives the PDU session establishment request from the UE.

The transmitting may include, after the calling, performing an SM policy association establishment procedure so that the SMF establishes an SM policy association with a policy control function (PCF) in conjunction with unified data repository (UDR) and obtains a default policy and charging control (PCC) rule for the service ID.

The PCC rule may include traffic identification information, target data network access identifier (DNAI) information, and/or N6 traffic routing information.

The transmitting may include, after the performing of the SM policy association establishment procedure, transmitting a SM policy control update request for the service ID to the PCF when the SMF confirms that there is no target DNAI mapped to the service ID by the CATS controller.

The transmitting may include, after the transmitting of the SM policy control update request, requesting, by the PCF, a new policy of the target DNAI of the PDU session for the service ID to which the user plane path information is attached to a network exposure function (NEF).

The transmitting may include, after the requesting of a new policy of the target DNAI of the PDU session, transmitting, by the NEF, the service ID to the CATS controller.

The reconfiguring of the user plane path may include receiving, by the NEF, a traffic influence request for the optimal service contact instance IP address from the CATS controller, and updating, by the NEF and the UDR, a new PCC rule for the Anycast IP address or the optimal service contact instance IP address and storing the new PCC rule.

The reconfiguring of the user plane path may include receiving, by the PCF, a rule change notification regarding a change of the user plane path to the optimal service contact instance IP address from the UDR after the storing, and transmitting, by the PCF, an SM policy rule update notification to the SMF.

The CATS controller may simultaneously transmit the traffic influence request and inject a routing policy into at least one of an ingress CATS router that knows about the base station to which the UE has connected and an egress CATS router that is aware of the service.

A geographically distributed dedicated user plane function (UPF) may be assigned to each of the plurality of service contact instances.

The method may include: after the reconfiguration of the user plane path is completed, selecting, by the SMF, a first UPF assigned to the optimal service contact instance IP address; requesting, by the SMF, the first UPF to establish an N4 session for a core network tunnel; and receiving, by the SMF, a tunnel endpoint ID (TEID) of the first UPF from the first UPF.

The method may include: after the receiving of the TEID, generating a session management context response using the optimal service contact instance IP address between the SMF and the AMF; transmitting, by the AMF, an N2 PDU session request to a radio access network (RAN) managing the base station; and completing a PDU session establishment between the RAN and the UE.

The method may include: after the completion of the PDU session establishment, transmitting, by the UE, initial uplink data to the first UPF via the ingress CATS router and the egress CATS router through a segment routing tunnel; transmitting, by the RAN, the TEID of the base station to which the UE is connected to the AMF; transferring, by the AMF, the TEID of the base station to the SMF; exchanging, by the SMF and the first UPF, session modification information including the TEID of the base station; and transmitting, by the UPF, initial downlink data to the UE via the egress CATS router and the ingress CATS router through an SRv6 tunnel.

When the UE transmits a packet destined for a destination to the base station, the base station may encapsulate the packet with a GTP-U header and transmit the encapsulated packet to the ingress CATS router, the ingress CATS router may remove the GTP-U header from the encapsulated packet, confirm routing policy mapping, and then, transmit the packet, which has pushed a segment routing header including a segment ID assigned to the IP address of the first UPF and the TEID of the first UPF as a parameter, to the egress CATS router, and the egress CATS router may remove the segment routing header from the received packet, generate a new GTP-U header, and transmit the new GTP-U header to the first UPF.

The method may include: after the reconfiguration of the user plane path is completed, setting, by the SMF, a default value for a core network tunnel endpoint ID (TEID) and an N3 IP address; generating a session management context response using the optimal service contact instance IP address between the SMF and the AMF; transmitting, by the AMF, an N2 PDU session request to a radio access network (RAN) managing the base station; and completing the PDU session establishment between the RAN and the UE.

The method may include: after the completion of the PDU session establishment, transmitting, by the UE, initial uplink data to the egress CATS router through a segment routing tunnel; transmitting, by the RAN, the TEID of the base station to which the UE has accessed to the AMF; transferring, by the AMF, the TEID of the base station to the SMF; and exchanging, by the SMF and the CATS controller, session modification information including the TEID of the base station.

The CATS controller may inject UE-base station information and SID mapping of the ingress CATS router using the IP address of the base station for a downlink path to the egress CATS router, and the egress CATS router may transmit initial downlink data to the UE through a segment routing tunnel.

When the UE transmits a packet destined for a destination to the base station, the base station encapsulates the packet with a GTP-U header and transmits the encapsulated packet to the ingress CATS router according to a default N3 IP address, and the ingress CATS router may remove the GTP-U header from the encapsulated packet, confirm routing policy mapping, and then, and transmit the packet which has pushed the segment routing header to the egress CATS router, and the egress CATS router may remove the segment routing header from the received packet and transmit the packet to the optimal service contact instance.

When a packet response is received from the optimal service contact instance, the egress CATS router may transmit a packet, which has pushed a segment routing header that uses the IP address of the base station as the last segment ID (SID) and the TEID of the base station as a parameter, to the ingress CATS router, according to a binding policy, and the ingress CATS router may remove the segment routing header from the packet received from the egress CATS router and generate a new GTP-U header with the IP address of the base station and transmit the new GTP-U to the base station.

According to another aspect of the present disclosure, there is provided a computing-aware traffic steering system in a mobile network, the computing-aware traffic steering system including: a control plane configured to transmit a service ID and user plane path information to a CATS controller in a computing-aware traffic steering (CATS) network environment using segment routing in a case where it is confirmed that there is no target data network access identifier (DNAI) mapped to the service ID when a PDU session establishment request including the service ID of a user equipment (UE) is made, and reconfigure a user plane path for accessing an optimal service contact instance IP address determined as one of a plurality of service contact instances based on a base station location connected by the UE and computing and networking metrics in conjunction with the CATS controller; and a data plane configured to transfer uplink data and downlink data between the UE and the optimal service contact instance according to the user plane path reconfiguration of the control plane.

According to still another aspect of the present disclosure, there is provided a user terminal connected to a mobile network system for computing-aware traffic steering, the user terminal including: a processor; and a memory connected to the processor, wherein the memory stores program commands executed by the processor to transmit a PDU session establishment request including a service ID to a mobile network control plane, and when it is confirmed that the control plane does not have a target data network access identifier (DNAI) mapped to the service ID, transmit the service ID and user plane path information to a CATS controller in a computing-aware traffic steering (CATS) network environment using segment routing, and reconfigure a user plane path for accessing an Any cast IP address corresponding to the service ID and an optimal service contact instance IP address determined as one of a plurality of service contact instances based on a base station location accessed by the UE and computing and networking metrics in conjunction with the CATS controller, and complete PDU session establishment with a radio access network (RAN), and after the PDU session establishment is completed, transmit uplink data to the optimal service instance through an ingress CATS router and an egress CATS router controlled by the CATS controller through a segment routing tunnel.

According to the present disclosure, there is an advantage in that user traffic of a user terminal connected to a mobile network can be dynamically steered to an optimal service contact instance.

### BRIEF DESCRIPTION OF DRAWINGS

FIGS. 1 and 2 illustrate a configuration of a mobile user plane (MUP) using segment routing.

FIG. 3 illustrates two types of paths in a case where path information for segment routing is obtained using a BGP routing protocol in an SR-MUP architecture.

FIG. 4 illustrates a case where multiple service instances are deployed in a fixed UPF environment.

FIG. 5 illustrates a case where a UPF dedicated to a service contact instance exists in a centralized CATS-supported mobile user plane architecture using SR.

FIGS. 6A and 6B illustrate a CATS-based PDU session establishment request procedure when a UPF dedicated to a service contact instance exists in a centralized CATS-supported mobile user plane architecture using the SR according to the present embodiment.

FIGS. 7A and 7B illustrate a process after user plane path reconfiguration for accessing an optimal service contact instance IP address according to the present embodiment.

FIG. 8 illustrates a packet encapsulation procedure according to the present embodiment.

FIG. 9 illustrates a bypass UPF mode in a centralized CATS-supported mobile user plane architecture using SR.

FIG. 10 illustrates a communication protocol between CATS-MUP-C and an underlay network according to the present embodiment.

FIGS. 11A and 11B illustrates a PDU session establishment request procedure in the bypass UPF mode based on a centralized CATS-supported mobile user plane architecture.

FIGS. 12A and 12B illustrate a process after user plane path reconfiguration for accessing an optimal service contact instance IP address in the bypass UPF mode according to the present embodiment.

FIG. 13 illustrates a packet encapsulation procedure in case 2.2 according to the present embodiment.

FIG. 14 illustrates a configuration of a user terminal according to a preferred embodiment of the present disclosure.

### DETAILED DESCRIPTION

The present disclosure can be modified in various ways and can have various embodiments, and specific embodiments are illustrated in the drawings and described in detail in the detailed description. However, this is not intended to limit the present disclosure to specific embodiments, and should be understood to include all modifications, equivalents, and substitutes included in the spirit and technical scope of the present disclosure.

The terms used in the present specification are used only to describe specific embodiments, and are not intended to limit the present disclosure. The singular expression includes the plural expression unless the context clearly indicates otherwise. In the present specification, the term “include” or “have” is intended to specify the presence of a feature, number, step, operation, component, part, or combination thereof described in the specification, and should be understood not to exclude in advance the possibility of the presence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope that the technical idea of the present disclosure is maintained, and it is also obvious that multiple embodiments may be re-implemented as one embodiment that is integrated even if a separate description is omitted.

In addition, when describing with reference to the attached drawings, the same components are given the same or related reference symbols regardless of the drawing symbols, and redundant descriptions thereof are omitted. In describing the present disclosure, if it is judged that a specific description of a related known technology may unnecessarily obscure the gist of the present disclosure, a detailed description thereof is omitted.

In a mobile network according to the present embodiment, computing-aware traffic steering may be performed based on segment routing (SR).

Hereinafter, the segment routing will be described in detail, focusing on the mobile network being a 5G network.

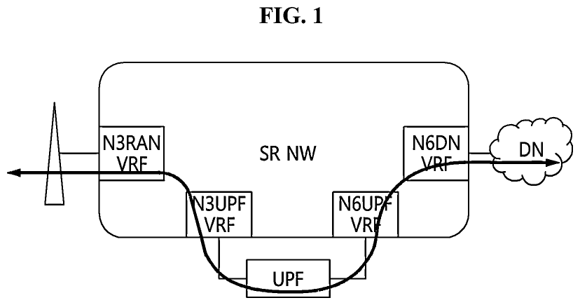

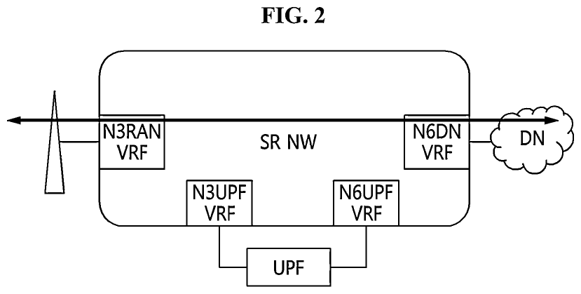

FIGS. 1 and 2 illustrate a mobile user plane (MUP) configured using the segment routing.

FIG. 1 illustrates a structure in which a PDU session is connected through an existing UPF in an SR underlay network.

Referring to FIG. 1, an existing 3GPP mobile network is connected to the SR underlay network without change.

Here, the SR underlay network may be an SRv6 underlay network.

This mode represents a structure in which a PDU session is connected through an existing UPF in an SR underlay network between two GTP-U (GPRS Tunneling Protocol User Plane) tunnel endpoints, and the SR underlay network provides the connection.

FIG. 2 illustrates a structure in which a PDU session is directly connected between two GTP-U (GPRS Tunneling Protocol User Plane) tunnel endpoints in an SR underlay network without using an existing UPF. Here, the SR underlay network provides the direct connection. This is named the SR-MUP architecture.

As illustrated in FIG. 2, using the SR-MUP architecture, an optimal path can be provided through the SRv6 underlay network without using a user plane function (UPF).

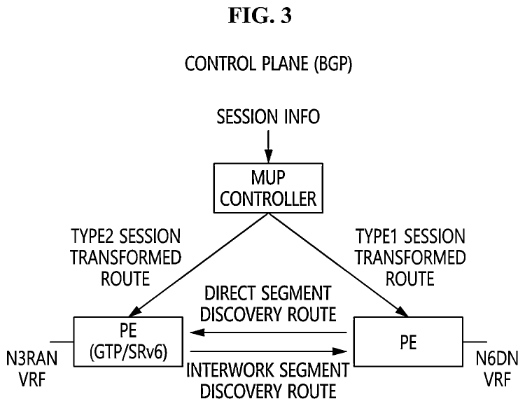

FIG. 3 illustrates two types of routes when obtaining route information for segment routing using a BGP routing protocol in the SR-MUP architecture.

Referring to FIG. 3, the route types for the SR-MUP architecture are as follows. Interwork Segment Discovery route: PE (Provider Edge node in an SR network) advertises this route for N3 interface discovery connected to a radio access network (RAN).

Direct Segment Discovery route: PE advertises this route for N6 interface discovery on a data network (DN) side.

Moreover, in relation to the path setting on the segment routing network linked from the PDU session information of the 5G control plane in the SR-MUP architecture, a route (Type1 session transformed route) transformed based on the information of Type 1 Session, which is a PDU session in a downlink direction, is set through MUP-C (Controller node for an SR network), and a route (Type2 session transformed route) transformed based on the information of the Type 2 Session, which is a PDU session in an uplink direction, is set through the MUP-C.

In addition to a 5G traditional approach of a mobile user plane (IP-based underlay network), various solutions for the mobile user plane, such as SRv6 or LISP for the mobile user plane, are being discussed.

In the present embodiment, a method for transferring user traffic to distributed service instances through computing-aware traffic steering will be described in the following various cases for the 5G mobile user plane.

In the present embodiment, using SRv6 with segment routing through IPv6 for the mobile user plane will be focused.

In the following, a case where multiple service instances are deployed behind a fixed UPF, a case where a dedicated UPF mode exists in the centralized CATS-supported mobile user plane architecture using the segment routing, and a bypassing UPF mode in a centralized CATS-supported mobile user plane architecture using the segment routing will be mainly described.

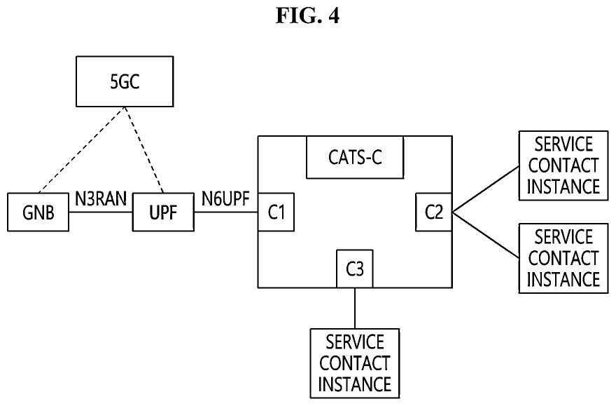

FIG. 4 illustrates a case where multiple service instances are deployed in a fixed UPF environment.

Referring to FIG. 4, multiple service contact instances are deployed behind the fixed UPF and are managed by a CATS-Controller (CAST-C).

The fixed UPF is defined as an ingress gateway for accessing one of multiple service contact instances through a CATS-C infrastructure network.

The fixed UPF is managed in a mobile network (for example, 5GC) control plane.

Whenever a user requests a given service with a service ID, the mobile network control plane selects the fixed UPF and establishes a packet data unit (PDU) session for User Equipment (UE).

Then, the UE sends user traffic through the fixed UPF, and the UPF transfers the user traffic to the ingress CATS router C1, and a CATS-C framework is responsible for computing- aware traffic steering for an optimal service contact instance IP.

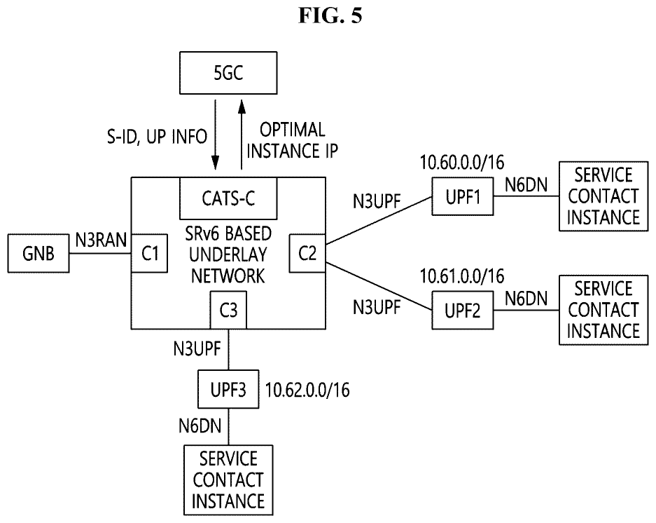

FIG. 5 illustrates a case where the UPF dedicated to the service contact instance exists in the centralized CATS-supported mobile user plane architecture using the SR.

Referring to FIG. 5, multiple dedicated UPFs (UPF 1 to UPF 3) for multiple service contact instances are deployed at geographically distributed edge sites and connected to a segment routing-based underlay network (SRv6 underlay network).

A user traffic to move to a specific service contact instance should first go through a dedicated UPF, and one UPF is dedicated to one service contact instance (for example, MEC case).

The SRv6 underlay network is conjunction with the mobile user plane architecture and does not require any changes to the existing 3GPP mobile network.

Service confirmation for mobile user traffic is handled by a centralized CATS-C via the mobile network control plane.

The CATS-C manages computing and networking metrics, supports communication with the mobile network control plane for traffic steering to the optimal service contact instance, and functions as the SRv6 underlay network control.

In the SRv6 underlay network, the ingress CATS router C1 and the egress CATS router C2 are also SRv6-aware nodes and are deployed with CATS functionality. The egress CATS router C2 acts as an SR gateway and can be aware of one or more UPFs via a segment routing identifier (SID) operation endpoint for the corresponding UPF interface.

In addition, the ingress CATS router C1 acts as an SR gateway using the SID operation endpoint for the gNB interface.

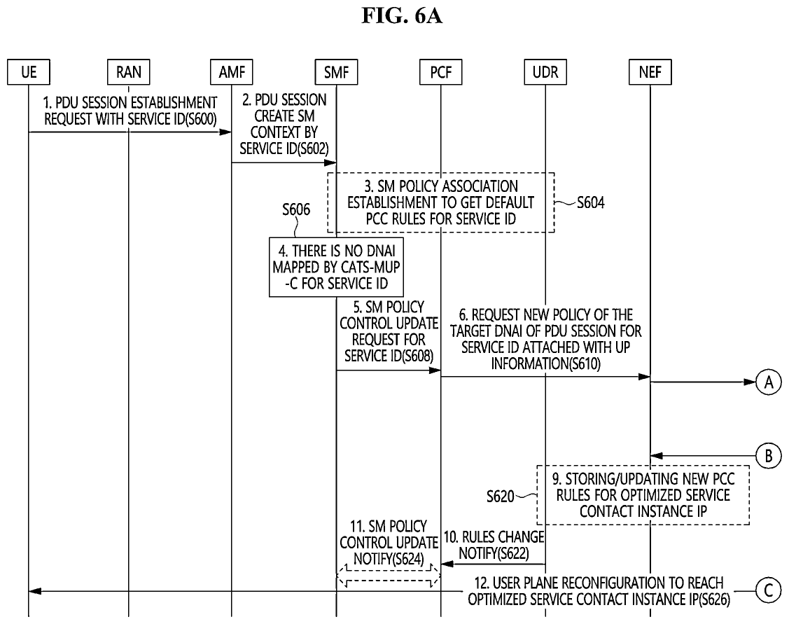

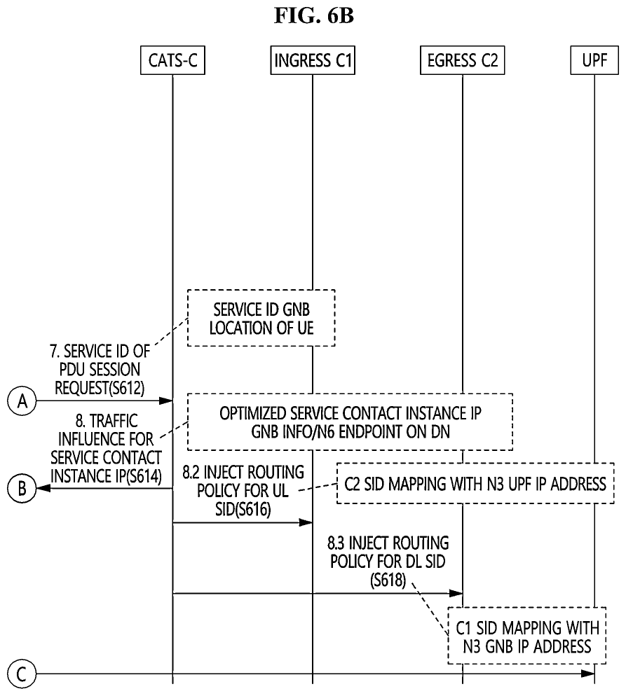

FIGS. 6A to 6B illustrate a CATS-based PDU session establishment request procedure in a case where a UPF dedicated to a service contact instance exists in the centralized CATS-supported mobile user plane architecture using the SR according to the present embodiment.

Referring to FIGS. 6A to 6B, whenever the UE joins a mobile network, the UE transmits the PDU session establishment request along with a service ID to an access and mobility management function (AMF) (Step 600). At this time, the AMF manages the mobility of the UE location.

In response to each request type, the AMF calls a PDU session create SM context request to the corresponding session management function (SMF) according to a data network name (DNN) corresponding to the service ID requested by the UE (Step 602).

The SMF performs a SM policy association establishment procedure to establish SM policy association with a policy control function (PCF) in conjunction with unified data repository (UDR) and obtain a default policy and charging control (PCC) rule for service ID (Step 604).

The PCC rule includes traffic identification information, target data network access identifier (DNAI) information, and/or N6 traffic routing information.

The UDR is a 5GC network solution that provides data storage and query function to 5G network function (NF).

When it is confirmed that there is no target DNAI mapped to the service ID by CATS-C (Step 606), the SMF transmits a message including target DNAI of PDU session and user plane path information to CATS-C (Steps 608 to 612).

Here, the user plane path information may be path information set as default to access a site corresponding to the service ID.

In Step 608, the SMF transmits a SM policy control update request for service ID is transmitted to the PCF.

Afterwards, in Step 610, the PCF requests a new policy for the target DNAI of the PDU session for the service ID with the user plane path information attached to a network exposure function (NEF).

In Step 612, the NEF transmits the service ID of the PDU session establishment request to the CATS-C.

As in Steps 608 to 612, the SMF may send a message including the target DNAI of the PDU session and user plane path information through the PCF, and then move to the CATS-C through the network exposure function (NEF).

The CATS-C extracts the user plane path information and collects essential parameters including the Anycast IP address corresponding to the service ID requested by the UE and the location of the gNB (base station) to which the UE is connected, and a CATS path selector (C- PS), which the function of the CATS-C, transmits a traffic influence request for the optimal service contact instance IP address determined based on the essential parameters to the NEF (Step 614).

At the same time, the CATS-C injects SRv6 policy (segment routing policy) to both the ingress CATS router C1 that knows about gNB to which the UE is connected and the egress CATS router C2 that is aware of service (Steps 616 to 618) to request the SRv6 underlay network to establish a tunnel between the gNB to which the UE is connected and a target UPF for connection to the optimal service contact instance IP address.

C2 SID mapping using N3 UPF IP address is performed by Step 616, and C1 SID mapping using N3 gNB IP address is performed by Step 618.

The NEF and UDR update new PCC rule (new PCC rule that changes user plane path) for the optimal service contact instance IP address and store the new PCC rule (Step 620).

The PCF receives the rule change notification about the user plane path change to the optimal service contact instance IP address from the UDR (Step 622).

The PCF transmits an SM policy rule update notification to the SMF (Step 624), and the SMF takes appropriate actions to reconfigure the user plane path of the corresponding PDU session to access the optimal service contact instance IP address, such as adding, replacing, or removing the UPF (Step 626).

After the PDU session is established and the CATS-C has already injected the routing policy into the ingress CATS router and the egress CATS router to establish a tunnel for the user traffic, the UE starts sending the packets to the target (optimal) service contact instance.

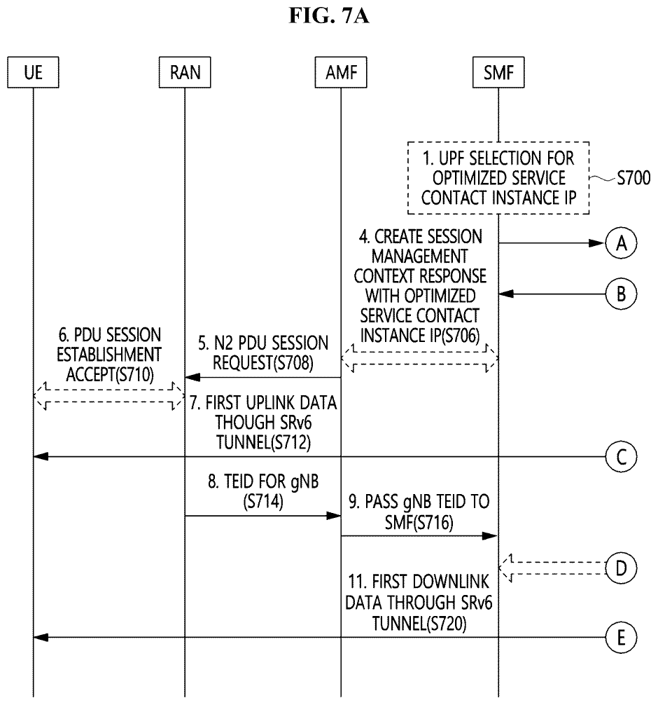

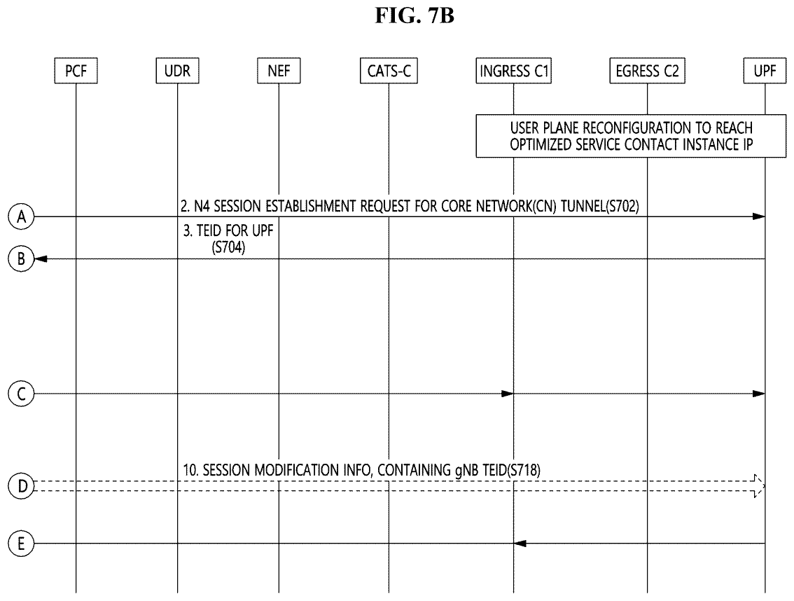

FIGS. 7A and 7B illustrate the process after the user plane path reconfiguration to access the optimal service contact instance IP address according to the present embodiment.

Referring to FIGS. 7A and 7B, after the user plane reconfiguration, the SMF selects the UPF specified in the optimal service contact instance IP address (Step 700) and requests the selected UPF for N4 session establishment for a core network (CN) tunnel (Step 702).

The UPF transmits a tunnel endpoint ID (TEID) of the UPF to the SMF (Step 704).

After Step 704, a session management context response using the optimal service contact instance IP address is generated between the SMF and the AMF (Step 706).

The AMF transmits an N2 PDU session request to the RAN (Step 708).

After that, PDU session establishment is performed between the RAN and the UE (Step 710).

After the PDU session establishment, the UE transmits initial uplink data to the UPF via the ingress CATS router C1 and the egress CATS router C2 through the SRv6 tunnel (Step 712).

The RAN transmits the TEID for the gNB to which the UE is connected to the AMF (Step 714), and the AMF transfers the TEID of the gNB to the SMF (Step 716).

Next, the SMF and the UPF exchange session modification information including the TEID of the gNB (Step 718).

Finally, the UPF transmits initial downlink data to the UE via the egress CATS router C2 and the ingress CATS router C1 through the SRv6 tunnel (Step 720).

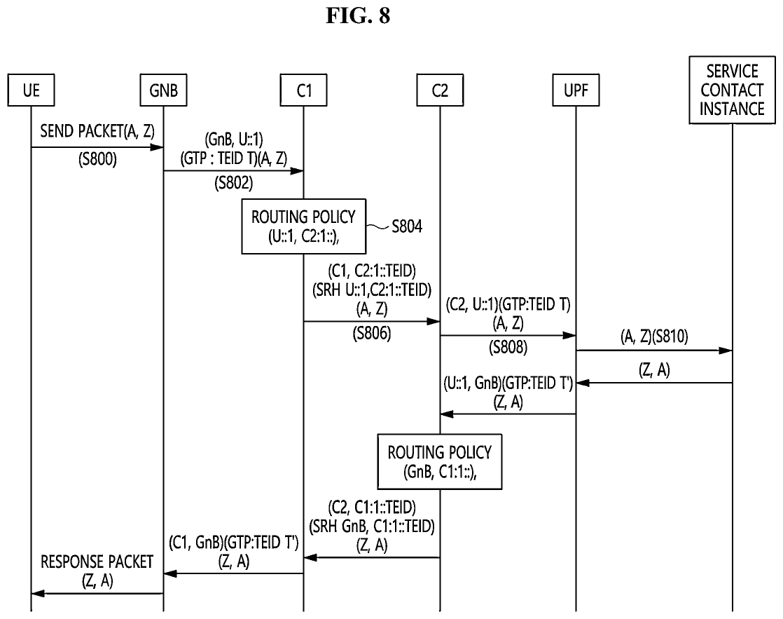

FIG. 8 illustrates a packet encapsulation procedure according to the present embodiment.

In FIG. 8, A is an IP address of the UE, Z is an IP address of the optimal service contact instance, C1 to C2 are IPV6 addresses (SIDs) assigned to the ingress CATS router C1 and egress CATS router C2 nodes, C2:1:: is an IPv6 address (SID) of the N3 UPF IP, C1:1:: is an IPv6 address (SID) of the N3 gNB, and U::1 is an IPv6 address (SID) of the UPF N3 interface associated with the gNB.

Referring to FIG. 8, when the UE transmits a packet destined for Z to the gNB (Step 800), the gNB encapsulates the packet with a GTP-U header (Step 802).

U::1 is the SRv6 binding SID according to the SRv6 policy, and the encapsulated packet is routed to C1.

The C1 removes the GTP-U header and confirms the corresponding routing policy mapping (U::1, C2:1::) (Step 804), then pushes the SRv6 header including the SID (U1::1) assigned to the N3 UPF IP and transfers C2:1:: (C2:1::TEID) with the TEID of the UPF as a parameter to C2 (Step 806).

When the packet arrives at C2, the C2 removes the SRv6 header, generates a new GTP-U header, pushes the SRv6 header to the packet, and transfers the packet to the UPF (Step 808).

The new IPv6 destination address (DA) is U::1 which is the last SID of a received segment routing header (SRH). The TEID of the generated GTP-U header is an argument of C2:1::TEID.

When the packet arrives at the UPF, a specific rule for the corresponding TEID is found and the packet is transferred to the target service contact instance (Step 810).

The same procedure is performed for downlink traffic.

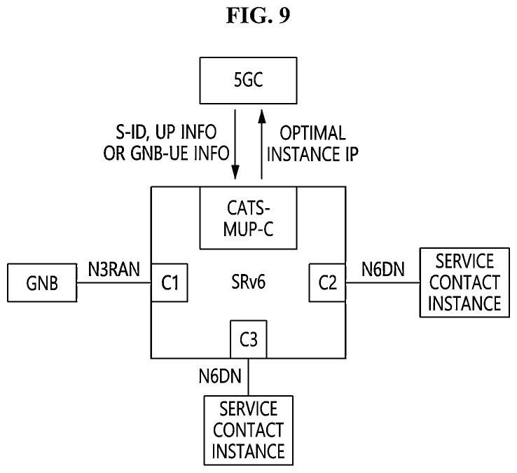

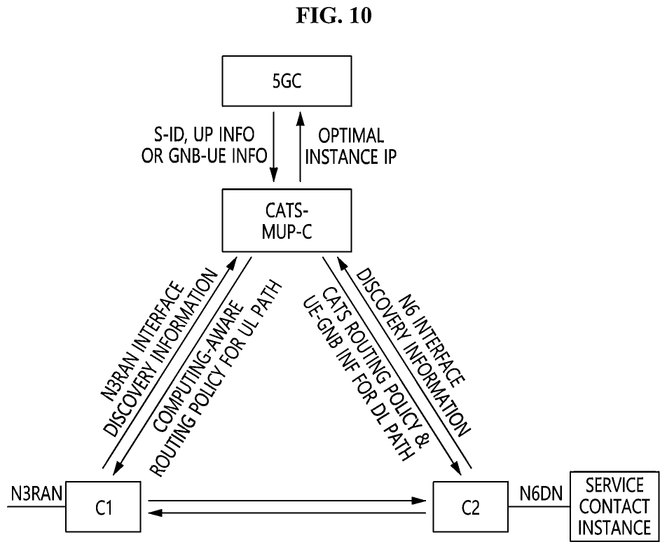

FIG. 9 illustrates the bypass UPF mode in the centralized CATS-supported mobile user plane architecture using SR, and FIG. 10 illustrates a communication protocol between the CATS-MUP-C and the underlay network according to the present embodiment.

Referring to FIGS. 9 and 10, in the bypass UPF mode in the centralized CATS-supported mobile user plane architecture, the service contact instance is not deployed behind the UPF, but is directly connected to the SRv6-based underlay network.

In the bypass UPF mode, the CATS-MUP-C is an MUP-C with a CATS controller function.

Here, the CATS-MUP-C communicates with 5GC control plane to receive SID, UP information or gNB-UE information from 5GC, and transfers the optimal service contact instance IP address to 5GC control plane to allow direct path between the UE and the target service contact instance without UPF intervention.

In this case, user traffic to move to a specific service contact instance does not need to go through UPF and can go directly to the service contact instance through the SRv6 underlay network.

With MUP function, the CATS-MUP-C converts session information into routing information and then injects the SRv6 routing policy to the corresponding ingress and egress CATS routers.

In addition, the CATS-MUP-C is responsible for communicating with the 5GC control plane to find the optimal service contact instance IP address based on the computing and networking metrics and the UE-gNB location.

In an underlay network infrastructure, the ingress CATS router C1 and the egress CATS router C2 are also the SRv6 aware nodes and are deployed with the CATS function.

The egress CATS router C2 acts as an SR gateway that can recognize one or more service contact instances through the SID operation endpoint using the corresponding interface.

In addition, the ingress CATS router C1 acts as the SR gateway using the SID operation endpoint for the gNB interface.

More specifically, referring to FIG. 10, in the SR-MUP architecture conjunction with the 5G control plane, the PE can connect to the N6 interface on the DN side, and the N6 interface search path for the DN is advertised from the PE to the CATS-MUP-C with the corresponding SID.

The N3 RAN interface search path for the N3 network that accommodates the RAN is advertised from the PE to the CATS-MUP-C with the RAN segment SID.

The CATS-MUP-C selects the optimal computing instance and the contact instance for the optimal computing instance based on the session information requested from the 5GC control plane, determines the path to the instance, and then advertises the corresponding routing policy to the segment routing domain.

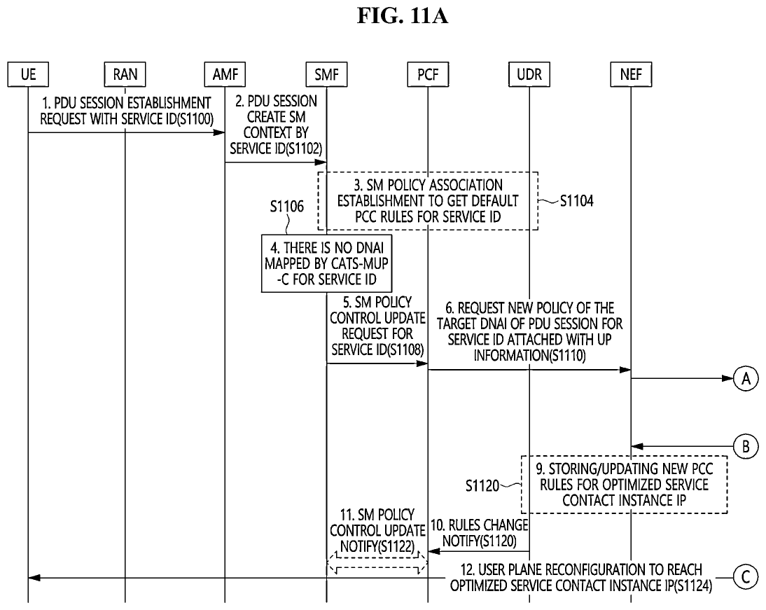

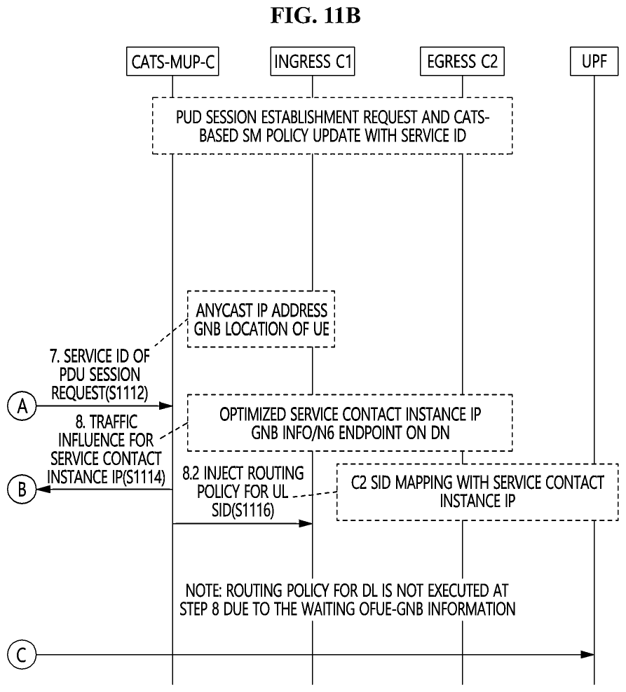

FIGS. 11A and 11B illustrates the PDU session establishment request procedure in the bypass UPF mode based on the centralized CATS-supported mobile user plane architecture.

Steps 1100 to 1114 of FIGS. 11A and 11B are identical to Steps 600 to 614 of FIGS. 6A and 6B.

In the bypass UPF mode, while generating a new PCC rule, the CATS-MUP-C requests the underlay network to establish a tunnel between the target service contact instance for the optimal service contact instance IP address and the gNB of the UE.

However, at this time, the routing policy for downlink traffic is not executed due to the UE-gNB information waiting, and the CATS-MUP-C injects only the routing policy for uplink traffic to the ingress CATS router C1 (Step 1116).

C2 SID mapping using the service contact instance IP address is performed in Step 1016.

Steps 1118 to 1124 are identical to Steps 620 to 626 of FIGS. 6A and 6B.

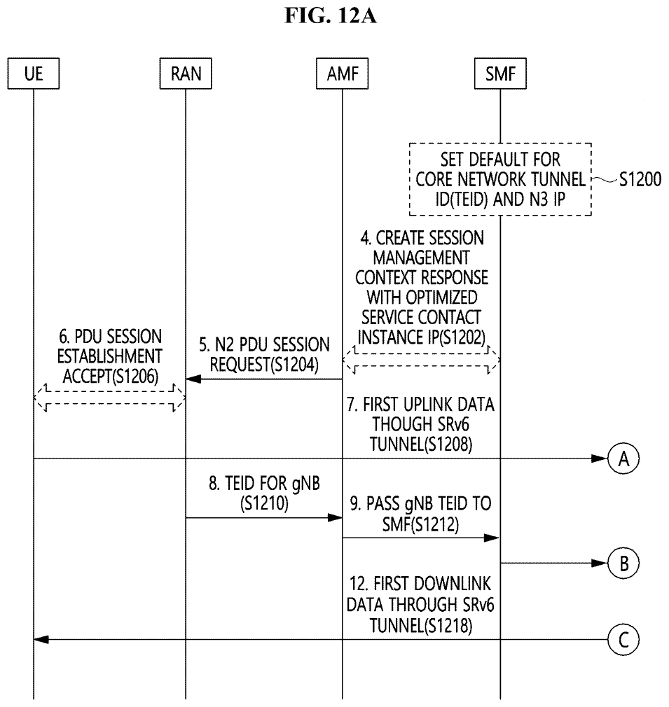

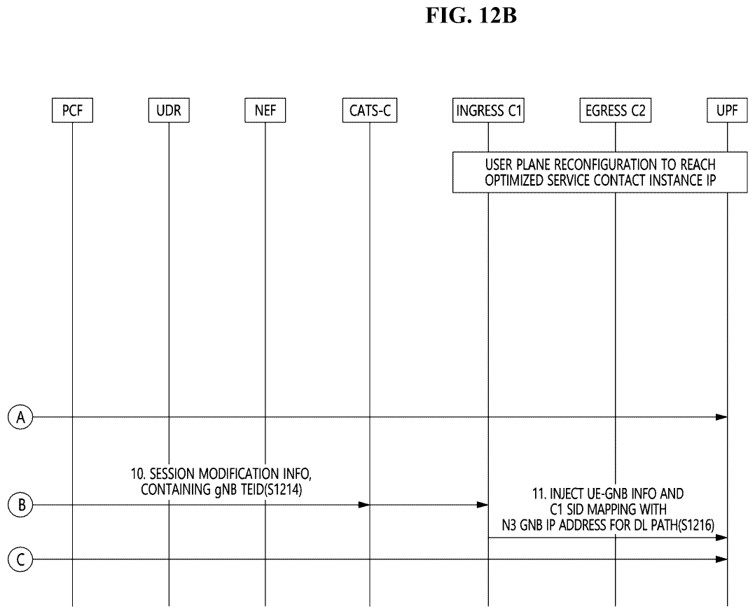

FIGS. 12A and 12B illustrate the process after the user plane path reconfiguration for accessing the optimal service contact instance IP address in the bypass UPF mode according to the present embodiment.

Referring to FIGS. 12A and 12B, after the user plane path reconfiguration is completed, the SMF sets default values for the core network tunnel endpoint ID (TEID) and the N3 IP address (Step 1200).

After Step 1200, a session management context response using the optimal service contact instance IP address is generated between the SMF and the AMF (Step 1202).

The AMF transmits the N2 PDU session request to the RAN (Step 1204).

After that, the PDU session establishment is performed between the RAN and the UE (Step 1206).

After the session establishment, the UE transmits initial uplink data to the egress CATS router C2 through the SRv6 tunnel (Step 1208).

The RAN transfers the gNB TEID to the AMF (Step 1210), and the AMF transfers the gNB TEID to the SMF (Step 1212).

Next, the SMF and CATS-MUP-C exchange the session modification information including the gNB TEID (Step 1214).

Afterwards, the CATS-MUP-C injects UE-gNB information along with mapping rules (C1 SID and N3 gNB IP address mapping) for the downlink path to the egress CATS router C2 to complete routing setup for downlink traffic (Step 1216).

Finally, the egress CATS router C2 transmits the initial downlink data to the UE through the SRv6 tunnel (Step 1218).

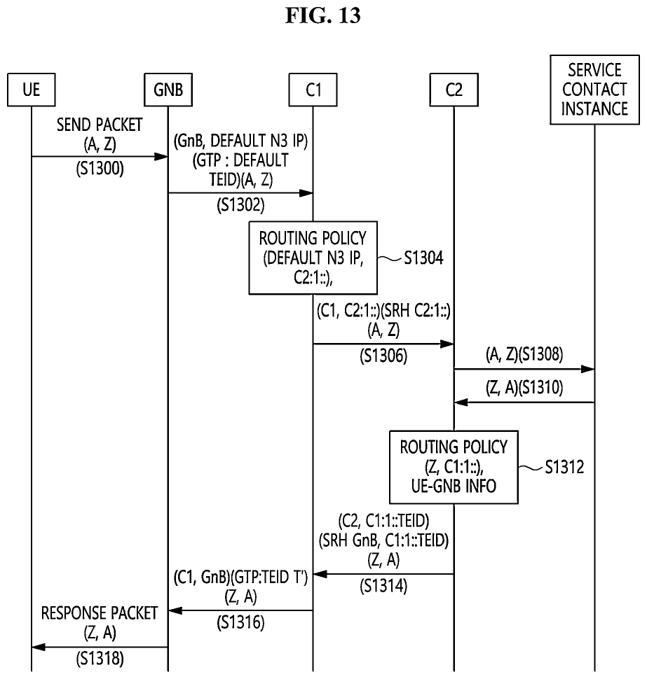

FIG. 13 illustrates a packet encapsulation procedure in case 2.2 according to the present embodiment.

When the UE transmits a packet destined for Z to the gNB (Step 1300), the gNB encapsulates the packet with a GTP-U header and transmits the packet to the default N3 IP (predefined) (Step 1302).

In Step 1302, the gNB encapsulates the packet with a GTP-U header and routes the packet to the ingress CATS router C1.

The C1 removes the GTP-U header from the received packet, confirms the routing policy mapping (Default N3 IP, C2:1::) (Step 1304), and then transmits the packet with the SRv6 header pushed to the egress CATS router C2 (Step 1306).

When the packet arrives at the C2, the C2 removes the SRv6 header and transfers the packet to the target service contact instance (Step 1308). When the packet response arrives at C2 (Step 1310), according to the binding policy (Z, C1:1::), the C2 pushes the SRv6 header to C1:1:: TEID using the IP address of the gNB as the last SID and gNB_TEID as a parameter (Step 1312) and transmits the packet to the C1 (Step 1314).

The C1 receives the packet, removes the SRv6 header, generates a new GTP-U header to the gNB IP address (the last SID of the SRv6 header), and transmits the new GTP-U header (Step 1316). The gNB transmits a packet response to the UE (Step 1318).

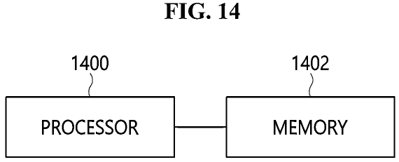

FIG. 14 illustrates a configuration of a user terminal according to a preferred embodiment of the present disclosure.

As illustrated in FIG. 14, the user terminal (UE) according to the present embodiment may include a processor 1400 and a memory 1402.

Here, the processor 1400 may include a central processing unit (CPU) capable of executing a computer program or a virtual machine, or the like.

The memory 1402 may include a nonvolatile storage apparatus such as a fixed hard drive or a removable storage apparatus. The removable storage apparatus may include a compact flash unit, a USB memory stick, or the like. The memory 1402 may also include a volatile memory such as various random access memories, and may be defined as a computer-readable recording medium.

The memory 1402 according to the present embodiment stores program commands that allow a user terminal connected to a mobile network to request the PDU session establishment using the service ID and access the optimal contact instance corresponding to the service ID.

The program commands according to the present embodiment transmit the PDU session establishment request including the service ID to the mobile network control plane, and when it is confirmed that the control plane does not have the target data network access identifier (DNAI) mapped to the service ID, transmit the service ID and user plane path information to the CATS controller in the computing-aware traffic steering network environment using the segment routing, and reconfigure a user plane path for accessing the optimal service contact instance IP address determined as one of a plurality of service contact instances based on a base station location accessed by the UE and computing and networking metrics in conjunction with the CATS controller, and then complete PDU session establishment with a radio access network (RAN), and after the PDU session establishment is completed, transmit the uplink data to the optimal service instance through the ingress CATS router and the egress CATS router controlled by the CATS controller through a segment routing tunnel.

The above-described embodiments of the present disclosure have been disclosed for the purpose of illustration, and those skilled in the art having common knowledge of the present disclosure will be able to make various modifications, changes, and additions within the spirit and scope of the present disclosure, and such modifications, changes, and additions should be considered to fall within the scope of the following claims.

What is claimed is:

1. A computing-aware traffic steering method of mobile network control plane, the method comprising:
in a case where it is confirmed that there is no target data network access identifier (DNAI) mapped to a service ID when a packet data unit (PDU) session establishment request including the service ID of a user equipment (UE) is made, transmitting the service ID and user plane path information to a computing-aware traffic steering (CATS) controller in a computing-aware traffic steering (CATS) network environment using segment routing; and
reconfiguring a user plane path for accessing an optimal service contact instance IP address determined as one of a plurality of service contact instances based on a base station connected by the UE and computing and networking metrics in conjunction with the CATS controller.

2. The method of claim 1, wherein the mobile network control plane is a control plane of a 5G or 6G mobile communication network, and
the transmitting includes calling a PDU session create session management (SM) context request to a corresponding session management function (SMF) according to a data network name (DNN) corresponding to the service ID when an access and mobility management function (AMF) of the control plane receives the PDU session establishment request from the UE.

3. The method of claim 2, wherein the transmitting includes, after the calling, performing an SM policy association establishment procedure so that the SMF establishes an SM policy association with a policy control function (PCF) in conjunction with unified data repository (UDR) and obtains a default policy and charging control (PCC) rule for the service ID.

4. The method of claim 3, wherein the PCC rule includes traffic identification information, the target data network access identifier (DNAI) information, and/or N6 traffic routing information.

5. The method of claim 4, wherein the transmitting includes, after the performing of the SM policy association establishment procedure, transmitting a SM policy control update request for the service ID to the PCF when the SMF confirms that there is no target DNAI mapped to the service ID by the CATS controller.

6. The method of claim 5, wherein the transmitting includes, after the transmitting of the SM policy control update request, requesting, by the PCF, a new policy of the target DNAI of the PDU session for the service ID to which the user plane path information is attached to a network exposure function (NEF).

7. The method of claim 6, wherein the transmitting includes, after the requesting of a new policy of the target DNAI of the PDU session, transmitting, by the NEF, the service ID to the CATS controller.

8. The method of claim 7, wherein the reconfiguring of the user plane path includes:
receiving, by the NEF, a traffic influence request for the optimal service contact instance IP address from the CATS controller, and
updating, by the NEF and the UDR, a new PCC rule for Anycast IP address or the optimal service contact instance IP address and storing the new PCC rule.

9. The method of claim 8, wherein the reconfiguring of the user plane path includes:
receiving, by the PCF, a rule change notification regarding a change of the user plane path to the optimal service contact instance IP address from the UDR after the storing, and transmitting, by the PCF, an SM policy rule update notification to the SMF.

10. The method of claim 8, wherein the CATS controller simultaneously transmits the traffic influence request and injects a routing policy into at least one of an ingress CATS router that knows about the base station to which the UE has connected and an egress CATS router that is aware of the service ID.

11. The method of claim 10, wherein a geographically distributed dedicated user plane function (UPF) is assigned to each of the plurality of service contact instances.

12. The method of claim 11, comprising:
selecting, by the SMF, a first UPF assigned to the optimal service contact instance IP address after the reconfiguration of the user plane path is completed;
requesting, by the SMF, the first UPF to establish an N4 session for a core network tunnel; and
receiving, by the SMF, a tunnel endpoint ID (TEID) of the first UPF from the first UPF.

13. The method of claim 12, comprising: after the receiving of the TEID,
generating a session management context response using the optimal service contact instance IP address between the SMF and the AMF;
transmitting, by the AMF, an N2 PDU session request to a radio access network (RAN) managing the base station; and
completing a PDU session establishment between the RAN and the UE.

14. The method of claim 13, comprising:
after the completion of the PDU session establishment, transmitting, by the UE, initial uplink data to the first UPF via the ingress CATS router and the egress CATS router through a segment routing tunnel;
transmitting, by the RAN, the TEID of the base station to which the UE is connected to the AMF;
transmitting, by the AMF, the TEID of the base station to the SMF;
exchanging, by the SMF and the first UPF, session modification information including the TEID of the base station; and
transmitting, by the UPF, initial downlink data to the UE via the egress CATS router and the ingress CATS router through an SRv6 tunnel.

15. The method of claim 14, wherein when the UE transmits a packet destined for a destination to the base station, the base station encapsulates the packet with a GTP-U header and transmits the encapsulated packet to the ingress CATS router,
the ingress CATS router removes the GTP-U header from the encapsulated packet, confirms routing policy mapping, pushes a segment routing header including a segment ID assigned to the IP address of the first UPF, and transmits a packet with the TEID of the first UPF as a parameter to the egress CATS router, and
the egress CATS router removes the segment routing header from the received packet, generates a new GTP-U header, and transmits the new GTP-U header to the first UPF.

16. The method of claim 10, wherein the plurality of service contact instances are directly connected to a segment routing underlay network without a user plane function (UPF) managed by the mobile network control plane.

17. The method of claim 16, comprising:
after the reconfiguration of the user plane path is completed, setting, by the SMF, a default value for a core network tunnel endpoint ID (TEID) and an N3 IP address;
generating a session management context response using the optimal service contact instance IP address between the SMF and the AMF;
transmitting, by the AMF, an N2 PDU session request to a radio access network (RAN) managing the base station; and
completing the PDU session establishment between the RAN and the UE.

18. The method of claim 17, comprising:
after the completion of the PDU session establishment, transmitting, by the UE, initial uplink data to the egress CATS router through a segment routing tunnel;
transmitting, by the RAN, the TEID of the base station to which the UE has accessed to the AMF;
transferring, by the AMF, the TEID of the base station to the SMF; and
exchanging, by the SMF and the CATS controller, session modification information including the TEID of the base station.

19. The method of claim 18, wherein the CATS controller injects UE-base station information and SID mapping of the ingress CATS router using the IP address of the base station for a downlink path to the egress CATS router, and
the egress CATS router transmits initial downlink data to the UE through a segment routing tunnel.

20. The method of claim 19, wherein when the UE transmits a packet destined for a destination to the base station, the base station encapsulates the packet with a GTP-U header and transmits the encapsulated packet to the ingress CATS router according to a default N3 IP address, and
the ingress CATS router removes the GTP-U header from the encapsulated packet, confirms routing policy mapping, and then, and transmits the packet which has pushed the segment routing header to the egress CATS router, and
the egress CATS router removes the segment routing header from the received packet and transmits the packet to the optimal service contact instance IP address.

21. The method of claim 20, wherein when a packet response is received from the optimal service contact instance IP address, the egress CATS router transmits a packet, which has pushed a segment routing header that uses the IP address of the base station as the last segment ID (SID) and the TEID of the base station as a parameter, to the ingress CATS router, according to a binding policy, and
the ingress CATS router removes the segment routing header from the packet received from the egress CATS router, generates a new GTP-U header with the IP address of the base station, and transmits the new GTP-U header to the base station.

22. A computing-aware traffic steering system in a mobile network, the computing-aware traffic steering system comprising:
a control plane configured to transmit a service ID and user plane path information to a computing-aware traffic steering (CATS) controller in a computing-aware traffic steering (CATS) network environment using segment routing in a case where it is confirmed that there is no target data network access identifier (DNAI) mapped to the service ID when a packet data unit (PDU) session establishment request including the service ID of a user equipment (UE) is made, and reconfigure a user plane path for accessing an optimal service contact instance IP address determined as one of a plurality of service contact instances based on a base station connected by the UE and computing and networking metrics in conjunction with the CATS controller; and
a data plane configured to transfer uplink data and downlink data between the UE and the optimal service contact instance IP address according to the user plane path reconfiguration of the control plane.

23. The computing-aware traffic steering system of claim 22, the control plane includes:
an access and mobility management function (AMF) configured to call PDU session create session management (SM) context request according to a data network name (DNN) corresponding to the service ID when receiving the PDU session establishment request from the UE, and
a session management function (SMF) called by the AMF and configured to perform an SM policy association establishment procedure to establish an SM policy association with a policy control function (PCF) in conjunction with a unified data repository (UDR) and obtain a default policy and charging control (PCC) rule for the service ID.

24. The computing-aware traffic steering system of claim 23, wherein when it is confirmed that there is no target DNAI mapped to the service ID by the CATS controller, the SMF transmits an SM policy control update request for the service ID to the PCF, and
the PCF requests a new policy of the target DNAI of the PDU session for the service ID to which the user plane path information is attached to a network exposure function (NEF).

25. A user terminal connected to a mobile network system for computing-aware traffic steering, the user terminal comprising:
a processor; and
a memory connected to the processor,
wherein the memory stores program commands executed by the processor to
transmit a packet data unit (PDU) session establishment request including a service ID to a mobile network control plane, and
when the mobile network control plane does not have a target data network access identifier (DNAI) mapped to the service ID, transmit the service ID and user plane path information to a computing-aware traffic steering (CATS) controller in a computing-aware traffic steering (CATS) network environment using segment routing, and reconfigure a user plane path for accessing an Anycast IP address corresponding to the service ID and an optimal service contact instance IP address determined as one of a plurality of service contact instances based on a base station accessed by a user equipment (UE) and computing and networking metrics in conjunction with the CATS controller, and complete PDU session establishment with a radio access network (RAN), and
after the PDU session establishment is completed, transmit uplink data to the optimal service contact instance IP address through an ingress CATS router and an egress CATS router controlled by the CATS controller through a segment routing tunnel.
